(19) United States
(12) Patent Application Publication
(10) Pub. No.: US 2007/0078797 A1
(43) Pub. Date: Apr. 5, 2007

(54) Method and system for parcel delivery in a ubiquitous environment and authenticaton server therefor

(75) Inventors: Jong Un Won, Suwon (KR); Jong Heung Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics & Telecommunications Research Institute

(21) Appl. No.: 11/510,253

(22) Filed: Aug. 24, 2006

(30) Foreign Application Priority Data
Oct. 11, 2005 (KR) 2005-0095553

(51) Int. Cl. G06F 17/00

(52) U.S. Cl. 705/408

(57) ABSTRACT

The invention provides a method and system for precise parcel delivery via mobile devices in a ubiquitous environment and an authentication server therefor. A reception center receives a request for parcel delivery from a sender and attaches a tag storing assigned individual ID and parcel information to the parcel. A deliverer terminal deciphers the tag attached to the parcel to confirm the parcel information and requests receiver authentication via the parcel information and receives an authentication result. Also, a receiver terminal transmits an electronic signature to an authentication server to request receiver authentication for the parcel delivered to a receiver. The authentication server assigns the individual ID to the parcel, transmits the individual ID to the reception center and authenticates the receiver according to the electronic signature transmitted from the receiver terminal. This allows precise parcel delivery to any place at any time.

### CLAIM OF PRIORITY

This application claims the benefit of Korean Patent Application No. 2005-0095553 filed on Oct. 11, 2005, in the Korean Intellectual Property Office, the disclosure of which is incorporated herein by reference.

### BACKGROUND OF THE INVENTION

1. Field of the Invention

The present invention relates to parcel delivery, and more particularly, to a method and system for parcel delivery in a ubiquitous environment and an authentication server therefor to deliver a parcel precisely via a mobile system in a ubiquitous environment.

2. Description of the Related Art

‘Parcel delivery’ means delivery of parcel, mail and etc. to a specified receiver by a logistics provider (e.g. a post office, a delivery service provider, a quick service provider)

The logistics provider performs delivery service for mail, package, parcel, and air baggage. Currently, the logistics provider carries out its basic duties through a multi-phased process such as reception/collection, sorting/allocation, and delivery. Meanwhile the logistics system and sorting technology have seen a development with respect to collection, sorting and allocation. Such a development has allowed sorting, allocation and delivery to be processed until the following day.

The aforesaid parcel delivery refers to all delivery services provided in this context.

Under a conventional parcel delivery system, at the request of a sender, an address of a receiver situated in a remote place is taken account of to locate the receiver, and then a parcel from the sender is handed over to the receiver. However, the conventional parcel delivery system has problems such as delayed or failed delivery arising from incorrect address, absence of receiver and error in receiver confirmation.

### SUMMARY OF THE INVENTION

The present invention has been made to solve the foregoing problems of the prior art and it is therefore an object of certain embodiments of the present invention to provide a method and system for mobile system-based parcel delivery in a ubiquitous environment and an authentication server therefor designed to ensure delivery to any place at any time and enhance reliability of delivery through receiver authentication.

It is another object of certain embodiments of the invention to provide a method and system for parcel delivery and an authentication server therefor to prevent delivery failure through receiver's electronic signature or authentication on delivery of a parcel.

According to an aspect of the invention for realizing the object, there is provided a parcel delivery system comprising: a reception center adapted to receive a request for parcel delivery from a sender, and attach a tag storing assigned individual ID and parcel information to the parcel; a deliverer terminal adapted to decipher the tag attached to the parcel to confirm the parcel information and request authentication for a receiver via the parcel information and receive an authentication result; a receiver terminal adapted to transmit an electronic signature to an authentication server in order to request receiver authentication for the parcel delivered to the receiver; and the authentication server adapted to assign the individual ID to the parcel, transmit the individual ID to the reception center and authenticate the receiver according to the electronic signature transmitted from the receiver terminal.

According to one embodiment of the invention, the reception center is adapted to request the authentication server to issue the individual ID to the parcel and receive the individual ID assigned by the authentication server.

According to another embodiment of the invention, the parcel information comprises at least one selected from a group consisting of names, residential numbers, addresses and telephone numbers of the sender and the receiver.

According to further another embodiment of the invention, the tag comprises at least one selected from a group consisting of a bar code, a radio frequency identification (RFID) tag and a bar code-printed RFID tag.

According to further another embodiment of the invention, the authentication server is adapted to store the parcel information.

According to further another embodiment of the invention, the authentication server may notify the receiver terminal of the individual ID and scheduled delivery information of the parcel.

According to further another embodiment of the invention, the authentication server comprises: a data transceiver adapted to transmit/receive data to/from the reception center; a wireless interface adapted to communicate with the deliverer terminal and the receiver terminal; an ID assigner adapted to assign the individual ID to the parcel; a data base adapted to store individual parcel ID, the parcel information, sender information and receiver information; a decipherer adapted to decipher the electronic signature transferred from the receiver terminal; and an authenticator adapted to authenticate the receiver via electronic signature.

According to further another embodiment of the invention, the data transceiver comprises: a receiver adapted to receive the parcel information and a request for individual ID assignment from the parcel reception center; and a transmitter adapted to assign the individual ID to the parcel in response to the request and transmit the same to the parcel reception center.

According to further another embodiment of the invention, the deliverer terminal comprises: a tag decipherer adapted to decipher information on the tag attached to the parcel; an authentication requester adapted to request the authentication server to authenticate the receiver via the deciphered information; and an authentication result receiver adapted to receive an authentication result in response to the request.

According to further another embodiment of the invention, the receiver terminal comprises: a signature inputter adapted to accept the electronic signature inputted by the receiver; a capturer adapted to capture an image corresponding to the electronic signature as data; and a transmitter adapted to transmit the captured electronic signature to the authentication server.

According to another aspect of the invention for realizing the object, there is provided an authentication server comprising: a receiver adapted to receive parcel information and a request for individual ID assignment to a parcel from a reception center; an ID assigner adapted to assign an individual ID to the parcel; a transmitter adapted to transmit the assigned individual ID of the parcel to the reception center; a wireless interface adapted to communicate with a deliverer terminal and a receiver terminal; a data base adapted to store the parcel information and the individual parcel ID; a decipherer adapted to decipher an electronic signature received from the receiver terminal; and an authenticator adapted to authenticate the receiver based upon electronic signature in response to a receiver authentication request from the deliverer terminal and transfer an authentication result to the deliverer terminal.

According to further another embodiment of the invention, the parcel information comprises one selected from a group consisting of names, residential numbers, addresses, and telephone numbers of a sender and the receiver of the parcel.

According to further another embodiment of the invention, the authentication server further comprises a notifier adapted to notify the receiver terminal of the individual ID and scheduled delivery information of the parcel.

According to further another embodiment of the invention, preferably, the individual ID is encoded to be transmitted.

According to further another aspect of the invention for realizing the object, there is provided a method for parcel delivery comprising steps of:
(i) at a reception center, receiving a request for parcel delivery, transmitting parcel information to an authentication server and requesting the authentication server to assign an individual ID to assign an individual ID to the parcel;
(ii) at the authentication server, assigning the individual ID to the parcel;
(iii) attaching a tag storing the individual ID and parcel information to the parcel and transferring the parcel to the receiver;
(iv) at the deliverer terminal, deciphering the tag before the parcel is handed over to the receiver, identifying receiver information, and requesting the authentication server to authenticate the receiver;
(v) at the authentication server, requesting the receiver terminal to send an electronic signature, receiving the electronic signature, and authenticating the receiver based on the electronic signature; and
(vi) at the deliverer terminal, receiving an authentication result from the authentication server, if the receiver is authenticated, handing over the parcel to the receiver.

According to further another embodiment of the invention, the method for parcel delivery further comprises notifying the receiver terminal of the individual parcel ID and scheduled delivery information via the parcel information after the step (ii).

The method of the invention further comprises notifying the receiver terminal of the individual parcel ID and scheduled delivery information via the parcel information.

According to further another embodiment of the invention, preferably the step (ii) comprises storing the individual parcel ID and the parcel information.

According to further another embodiment of the invention, preferably, the parcel information comprises one selected from a group consisting of names, residential numbers, addresses, and telephone numbers of a sender and the receiver of the parcel.

According to further another embodiment of the invention, the step (iv) comprises accessing the authentication server via wired or wireless communication to request authentication for the receiver.

According to further another embodiment of the invention, the step (v) comprises deciphering the received electronic signature.

According to further another embodiment of the invention, the tag comprises one selected from a group consisting of a bar code, a radio frequency identification (RFID) tag, and a bar code-printed RFID tag.

According to yet another embodiment of the invention, preferably the step (v) further comprises:
at the receiver terminal, upon receiving the electronic signature request,
accepting the electronic signature inputted by the receiver;
capturing an image corresponding to the inputted signature as data; and
transmitting the captured electronic signature to the authentication server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration view of a parcel delivery system according to an embodiment of the invention;

FIG. 2 is a configuration view of an authentication server for parcel delivery according to an embodiment of the invention;

FIG. 3 is a configuration view of a deliverer terminal employed in a parcel delivery system of the invention;

FIG. 4 is a configuration view of a receiver terminal employed in a parcel delivery system of the invention;

FIG. 5 is a procedural view illustrating a parcel delivery system according to an embodiment of the invention; and

FIG. 6 is a flow chart showing a process of an authentication server for parcel delivery.

### DETAILED DESCRIPTION OF THE PREFERRED EMBODIMENT

Preferred embodiments of the present invention will now be described in detail with reference to the accompanying drawings. In the following description, well-known functions and constructions are not described in detail since they would obscure the intention in unnecessary detail.

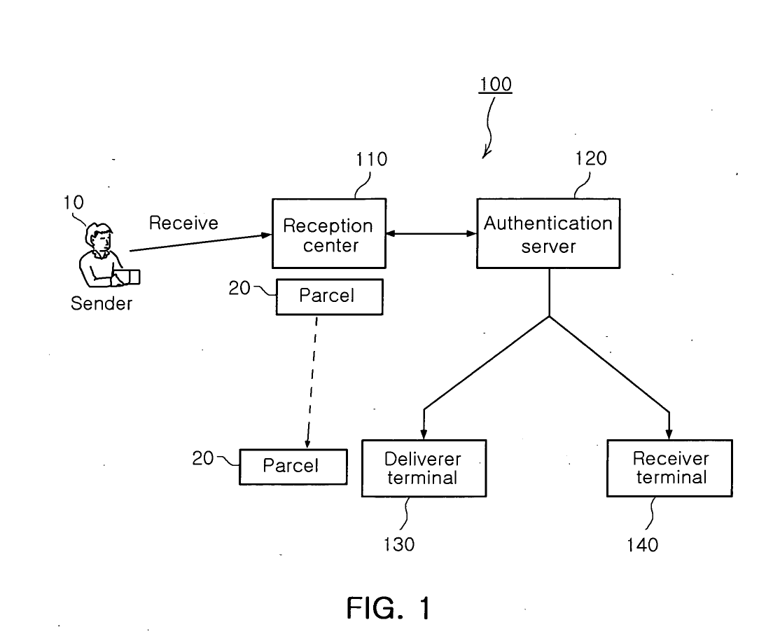

FIG. 1 is a configuration view of a parcel delivery system according to one embodiment of the invention.

Referring to FIG. 1, a parcel delivery system 100 includes a reception center 110, an authentication server 120, a deliverer terminal 130 and a receiver terminal 140.

The reception center 110 receives a request for parcel delivery from a sender 10. Then the reception center 110 transmits information on the parcel to an authentication server 120 and requests the authentication server 120 to issue the individual ID to the parcel. The parcel information includes information on a sender and a receiver. More specifically, the parcel information includes at least one selected from a group consisting of names, residential numbers, addresses, and telephone numbers of the sender and receiver. The parcel information may include pictures of the sender and the receiver if necessary.

The reception center 110 receives an individual ID for a parcel assigned by the authentication server 120, and attaches a tag storing the individual ID and parcel information to the parcel. Preferably, the tag may be one selected from a group consisting of a bar code, a radio frequency identification (RFID) tag and an RFID tag printed with such bar code. The parcel attached with the tag is transferred to a deliverer and then to the receiver.

The authentication server 120 stores the parcel information transmitted from the reception center 110, and assigns the individual ID to the parcel in response to a request for individual ID issuance for the parcel. Here, preferably, the individual ID may be encoded variously. The authentication server 120 identifies information on the receiver via the parcel information and notifies the receiver terminal 140 of the assigned individual ID and scheduled delivery information. For example, the scheduled delivery information includes information on when and where to deliver a specified parcel.

The authentication server 120 receives a request for receiver authentication from the deliverer terminal 130. Then the authentication server 120 uses pre-stored parcel information to search the receiver, and requests the receiver terminal 140 to transmit an electronic signature to authenticate the receiver. Thereafter, the authentication receiver 120 receives electronic signature from the receiver terminal 140, deciphers the electronic signature, authenticates the receiver and transmits an authentication result to the deliverer terminal 130.

The deliverer terminal 130 is a mobile terminal carried by the deliverer. In case of receiving the parcel from the reception center 110, the deliverer carrying the deliverer terminal 130 hands over the parcel to the receiver via the parcel information. Before handing over the parcel to the receiver, the deliverer needs to confirm whether or not the receiver is a legitimate receiver. Therefore, the deliverer uses the deliverer terminal 130 possessed by the deliverer to decipher the tag attached to the parcel. Here, it should be noted that the deliverer terminal 130 includes a certain tag deciphering means for deciphering the tag attached to the parcel. In this case, the deliverer terminal 130 confirms the individual ID and parcel information by deciphering the tag and especially requests the authentication server 120 to authenticate the receiver based upon the parcel information. Thereafter, the deliverer terminal receives an authentication result from the authentication server 120, and if the receiver is authenticated, the parcel is handed over to the receiver. If the receiver is not authenticated, preferably, the parcel should not be handed over.

The receiver terminal 140 is a mobile terminal carried by the receiver. As stated above, the deliverer carrying the deliverer terminal 130 brings the parcel to the receiver. After the deliverer terminal 130 and authentication server 120 communicate with each other, the receiver terminal 140 receives a request from the authentication server 120 to transmit the electronic signature to authenticate a receiver. In response, the receiver terminal 120 receives the electronic signature of the receiver and transmits the same to the authentication server 120.

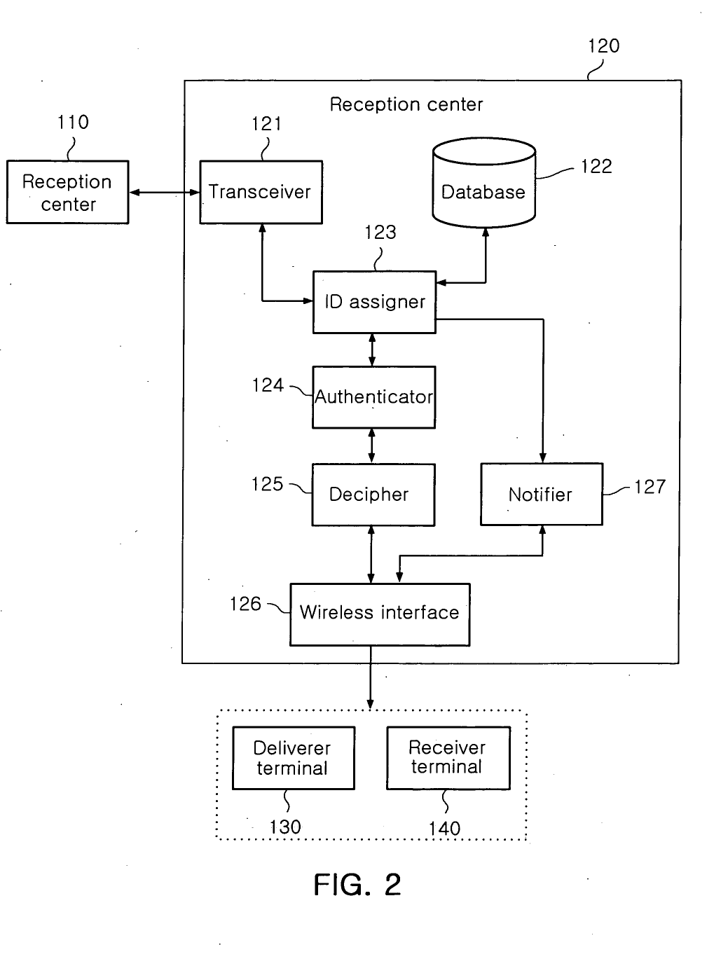

FIG. 2 is a configuration view of an authentication server for a parcel delivery system according to an embodiment of the invention. As shown in FIG. 2, an authentication server 120 for parcel delivery of the invention includes a transceiver 121, a database 122, and an ID assigner 123, an authenticator 123, a decipherer 125, a wireless interface 126 and a notifier 127.

The transceiver 121 transmits/receives data to/from a reception center 110. Particularly, although not illustrated, the transmitter/receiver 121 includes a receiver adapted to receive parcel information and a request for individual ID assignment to a parcel from the reception center 110 and a transmitter adapted to transmit the assigned individual parcel ID to the reception center 110.

The database DB 122 stores the parcel information transmitted from the reception center 110 and the individual parcel ID. The parcel information includes at least one selected from a group consisting of names, residential numbers, addresses, telephone numbers of the sender and receiver. The parcel information may include pictures of the sender and receiver if necessary.

The ID assigner 123 assigns an individual ID to the parcel in response to a request from the reception center 110. The individual ID is an identifier which enables identification of the parcel and preferably is encoded.

The authenticator 124 authenticates the receiver at the request of the deliverer terminal 130. Especially, the authenticator 124 uses an electronic signature of the receiver, which is transmitted from the receiver terminal 140 and deciphered, to authenticate the receiver, and transmits a result to the deliverer terminal 130. A method for receiver authentication by the authenticator 124 can be configured variously. Since such an authentication method can be easily carried out by those skilled in the art, a detailed explanation will not be given.

The decipherer 125 deciphers the electronic signature of the receiver transmitted from the receiver terminal 140 to the authentication server 120. The electronic signature needs to be deciphered when the authenticator 124 authenticates the receiver.

The wireless interface 126 interfaces with the deliverer terminal 130 and receiver terminal 140 through a mobile telecommunication network.

The notifier 127 communicates data with the deliverer terminal 130 and receiver terminal 140 through the wireless interface 126. Especially, the notifier 127 notifies the receiver terminal 140 of the individual parcel ID and scheduled delivery information. Further, the notifier 127 receives a request for receiver authentication from the deliverer terminal 130 through the wireless interface 126, and transmits an authentication result to the deliverer terminal 130 through the wireless interface 126.

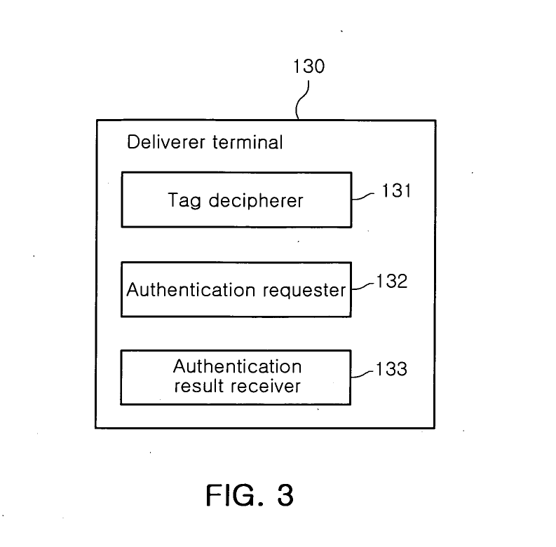

FIG. 3 is a configuration view of a deliverer terminal employed in a parcel delivery system of the invention.

Referring to FIG. 3, the deliverer terminal 130 of the invention includes a tag decipherer 131, an authentication requester 132 and an authentication result receiver 133.

The tag decipherer 131 deciphers information on a tag attached to a parcel. The tag information includes parcel information and an individual ID assigned to the parcel. Therefore, the tag decipherer 131 deciphers the tag information, thereby confirming information on the sender/receiver and the assigned individual ID.

The authentication requester 132 requests the authentication server 120 to authenticate the receiver based on the tag information deciphered by the tag decipherer 131.

The authentication result receiver 133 receives an authentication result from the authentication server 120 in response to a request for receiver authentication.

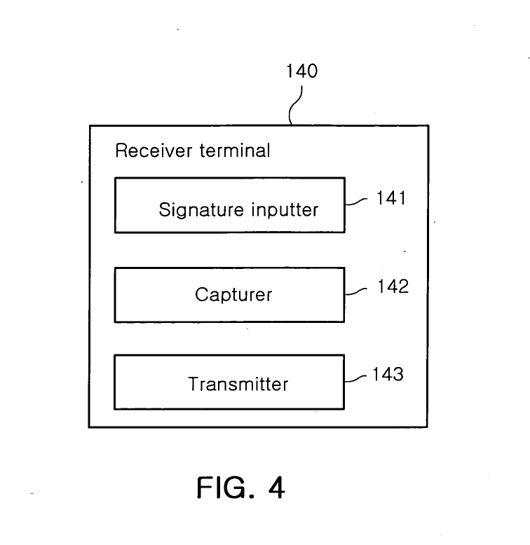

FIG. 4 is a configuration view of a receiver terminal employed in a parcel delivery system of the invention.

As shown in FIG. 4, a receiver terminal 140 of the invention includes a signature inputter 141 adapted to accept an electronic signature inputted by the receiver, a capturer 142 adapted to capture an image corresponding to the inputted electronic signature as data, and a transmitter 143 adapted to transmit the captured electronic signature to the authentication server 120.

The receiver terminal 141 accepts the electronic signature inputted by the receiver via the signature inputter 141. The capturer 142 captures the inputted electronic signature as data to store. The transmitter 143 transmits the electronic signature to the authentication server 120.

Preferably, the electronic signature inputter 141 may include a corded or wireless pen, or a tablet with a puck. According to this embodiment of the invention, the receiver writes signature via the pen or tablet with the puck so that a curser on the screen draws corresponding image, which is then captured as data in real-time.

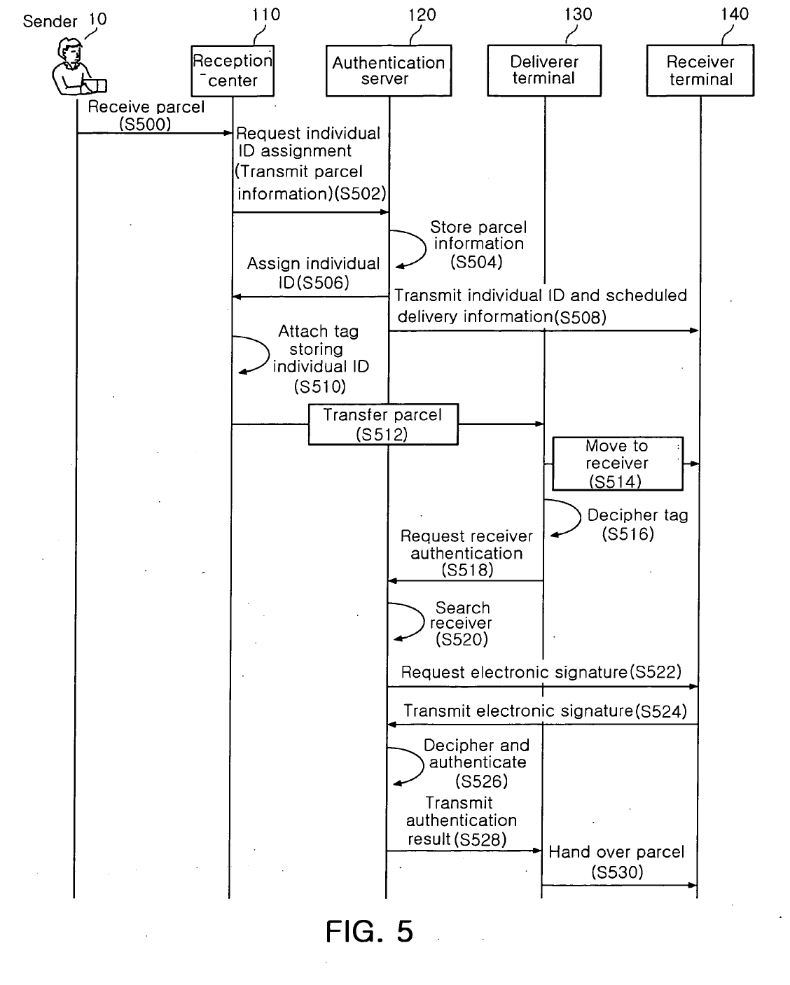

FIG. 5 is a procedural view showing a method for delivering a parcel of the invention.

Referring to FIG. 5, the reception center 110 receives a request for parcel delivery from a sender 10 in S500. The reception center 110 transmits parcel information to an authentication server 120 and requests the authentication server 120 to assign an individual ID to the parcel in S502. The parcel information includes information on the sender and receiver. More specifically, the parcel information may include one selected from a group consisting of names, residential numbers, addresses, telephone numbers of the sender and receiver of the parcel. The parcel information may include pictures of the sender and receiver if necessary.

Then, the authentication server 120 stores the parcel information transmitted from the reception center 110 in S504 and assigns the individual ID to the parcel in response to a request for individual ID issuance in S506. Here, preferably, the individual ID maybe encoded variously. The authentication server 120 uses the parcel information to identify receiver information and notifies the receiver terminal 140 of the individual ID assigned to the parcel and scheduled delivery information in S508. For example, the scheduled delivery information includes information on when and where to deliver a specified parcel.

The reception center 110 receives the individual parcel ID assigned by the authentication server 120 and attaches a tag storing the individual ID and parcel information to the parcel in S510. Preferably, the tag may include one selected from a group consisting of a bar code, a radio frequency identification (RFID) tag and an RFID tag printed with such bar code. The parcel attached with the tag is transferred to the deliverer possessing the deliverer terminal 130 in S512. Thereafter the deliverer vistits the receiver with the parcel in S514.

In order to confirm whether the receiver is a legitimate receiver before handing over the parcel to the receiver, the deliverer terminal 130 deciphers the tag attached to the parcel and confirms the individual parcel ID and parcel information in S516. The tag can be deciphered via a tag decipherer included in the deliverer terminal 130. Thereafter, the deliverer terminal 130 requests the authentication server 120 to authenticate the receiver via the parcel information in S518.

The authentication server 120, upon receiving a request for receiver authentication from the deliverer terminal 130, searches for the receiver via the parcel information which is pre-stored in S520. Then the authentication server 120 requests the receiver terminal 140 to send an electronic signature for receiver authentication in S522. In response to the request by the authentication server 120, the receiver terminal 140 accepts the electronic signature from the receiver and transmits the same to the authentication server 120 in S524.

Then, the authentication server 120 receives the electronic signature of the receiver from the receiver terminal 140, deciphers the electronic signature, and authenticates the receiver in S526, and then transmits an authentication result to the deliverer terminal 130 in S528. The deliverer terminal 130 hands over the parcel to the receiver if the receiver is authenticated in S530.

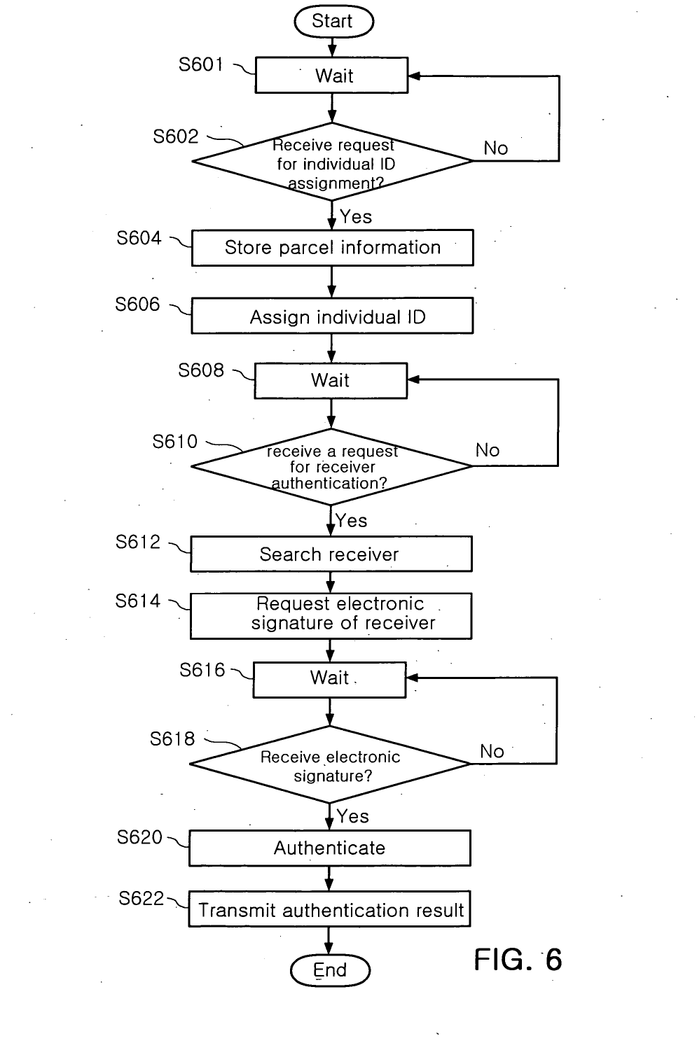

FIG. 6 is a flow chart showing a process of an authentication server for parcel delivery of the invention. Referring to FIG. 6, an authentication server of the invention waits until receiving a request for individual ID issuance from a reception center 110 in S600. If the authentication server receives parcel information and a request for individual ID assignment in S602, it stores the parcel information in S604, assigns an individual ID to the parcel in S606, and then waits for a next input in S608.

Thereafter, it is judged whether or not the authentication server has received a request for receiver authentication from the deliverer terminal 130 in S610. If the request is received, the authentication server 120 searches for the receiver via the parcel information in S612. Then, the authentication server 120 requests the receiver terminal 140 to transmit an electronic signature for receiver authentication in S614, and then waits for a next input in S616.

Further, it is judged whether or not the authentication server 120 has accepted electronic signature inputted by the receiver terminal 140 in S618. If the electronic signature is accepted, the authentication server 120 deciphers the electronic signature and authenticates the receiver in S620. Then, the authentication server 120 transmits an authentication result to the deliverer terminal 130 in S622.

A certain embodiment of the invention as set forth above allows more precise delivery, subsequently preventing errors and failures in delivery, and ensures delivery to any place at any time.

Also, a certain embodiment of the invention enhances reliability of delivery by authenticating the receiver via the electronic signature on delivery of the parcel.

While the present invention has been shown and described in connection with the preferred embodiments, it will be apparent to those skilled in the art that modifications and variations can be made without departing from the spirit and scope of the invention as defined by the appended claims.

What is claimed is:

1. A parcel delivery system comprising:
a reception center adapted to receive a request for parcel delivery from a sender, and attach a tag storing assigned individual ID and parcel information to the parcel;
a deliverer terminal adapted to decipher the tag attached to the parcel to confirm the parcel information and request authentication for a receiver via the parcel information and receive an authentication result;
a receiver terminal adapted to transmit an electronic signature to an authentication server in order to request receiver authentication for the parcel delivered to the receiver; and
an authentication server adapted to assign the individual ID to the parcel, transmit the individual ID to the reception center and authenticate the receiver according to the electronic signature transmitted from the receiver terminal.

2. The parcel delivery system according to claim 1, wherein the reception center is adapted to request the authentication server to issue the individual ID to the parcel and receive the individual ID assigned by the authentication server.

3. The parcel delivery system according to claim 1, wherein the parcel information comprises at least one selected from a group consisting of names, residential numbers, addresses and telephone numbers of the sender and the receiver.

4. The parcel delivery system according to claim 1, wherein the tag comprises at least one selected from a group consisting of a bar code, a radio frequency identification (RFID) tag and a bar code-printed RFID tag.

5. The parcel delivery system according to claim 1, wherein the authentication server comprises:
a data transceiver adapted to transmit/receive data to/from the reception center;
a wireless interface adapted to communicate with the deliverer terminal and the receiver terminal;
an ID assigner adapted to assign the individual ID to the parcel;
a data base adapted to store individual parcel ID, the parcel information, sender information and receiver information;
a decipherer adapted to decipher the electronic signature transferred from the receiver terminal; and
an authenticator adapted to authenticate the receiver via the electronic signature.

6. The parcel delivery system according to claim 5, wherein the data transceiver comprises:
a receiver adapted to receive the parcel information and a request for individual ID assignment from the parcel reception center; and
a transmitter adapted to assign the individual ID to the parcel in response to the request and transmit the same to the parcel reception center.

7. The parcel delivery system according to claim 1, wherein the deliverer terminal comprises:
a tag decipherer adapted to decipher information on the tag attached to the parcel;
an authentication requester adapted to request the authentication server to authenticate the receiver via the deciphered information; and
an authentication result receiver adapted to receive an authentication result in response to the request.

8. The parcel delivery system according to claim 1, wherein the receiver terminal comprises:
a signature inputter adapted to accept the electronic signature inputted by the receiver;
a capturer adapted to capture an image corresponding to the electronic signature as data; and
a transmitter adapted to transmit the captured electronic signature to the authentication server.

9. An authentication server comprising:
a receiver adapted to receive parcel information and a request for individual ID assignment to a parcel from a reception center;
an ID assigner adapted to assign an individual ID to the parcel;
a transmitter adapted to transmit the assigned individual ID of the parcel to the reception center;
a wireless interface adapted to communicate with a deliverer terminal and a receiver terminal;
a data base adapted to store the parcel information and the individual parcel ID;
a decipherer adapted to decipher an electronic signature received from the receiver terminal; and
an authenticator adapted to authenticate the receiver based on electronic signature in response to a receiver authentication request from the deliverer terminal and transfer an authentication result to the deliverer terminal.

10. The authentication server according to claim 9, wherein the parcel information comprises one selected from a group consisting of names, residential numbers, addresses, and telephone numbers of a sender and the receiver of the parcel.

11. The authentication server according to claim 9, further comprising a notifier adapted to notify the receiver terminal of the individual ID and scheduled delivery information.

12. A method for parcel delivery comprising steps of:
(i) at a reception center, receiving a request for parcel delivery, transmitting parcel information to an authentication server and requesting the authentication server to assign an individual ID to the parcel;
(ii) at the authentication server, assigning the individual ID to the parcel;
(iii) attaching a tag storing the individual ID and parcel information to the parcel and transferring the parcel to the receiver;
(iv) at the deliverer terminal, deciphering the tag before the parcel is handed over to the receiver, identifying receiver information, and requesting the authentication server to authenticate the receiver;
(v) at the authentication server, requesting the receiver terminal to send an electronic signature, receiving the electronic signature, and authenticating the receiver based on the electronic signature; and
(vi) at the deliverer terminal, receiving an authentication result from the authentication server, if the receiver is authenticated, handing over the parcel to the receiver.

13. The method according to claim 12, further comprising notifying the receiver terminal of the individual parcel ID and scheduled delivery information via the parcel information.

14. The method according to claim 12, further comprising storing the individual parcel ID and the parcel information.

15. The method according to claim 12, wherein the step (iv) comprises accessing the authentication server via wired or wireless communication to request authentication for the receiver.

16. The method according to claim 12, wherein the step (v) comprises interpreting the received electronic signature.

17. The method according to claim 12, wherein the tag comprises one selected from a group consisting of a bar code, a radio frequency identification (RFID) tag, and a bar code-printed RFID tag.

18. The method according to claim 12, wherein the step (v) further comprises:
at the receiver terminal, upon receiving the electronic signature request,
accepting the electronic signature inputted by the receiver;
capturing an image corresponding to the inputted signature as data; and
transmitting the captured electronic signature to the authentication server.
